(19) United States
(12) Patent Application Publication
(10) Pub. No.: US 2025/0091563 A1
(43) Pub. Date: Mar. 20, 2025

(54) BRAKE SYSTEM FOR A MOTOR VEHICLE

(71) Applicant: Continental Automotive Technologies GmbH, Hannover (DE)

(72) Inventors: Jochen Führer, Darmstadt (DE); Marc Grätsch, Alsheim (DE); Roland Caspari, Frankfurt (DE); Sebastian Mihm, Usingen (DE)

(73) Assignee: Continental Automotive Technologies GmbH, Hannover (DE)

(21) Appl. No.: 18/726,895

(22) PCT Filed: Dec. 19, 2022
(86) PCT No.: PCT/DE2022/200306

§ 371 Date: Jul. 5, 2024

(30) Foreign Application Priority Data
Jan. 7, 2022 (DE) 10 2022 200 105.2

(51) Int. Cl. B60T 13/74; B60T 8/40; B60T 13/66

(52) U.S. Cl. CPC B60T 13/745; B60T 8/4081; B60T 13/662

(57) ABSTRACT

A brake system for a motor vehicle for at least four hydraulically actuable wheel brakes, including one electrically actuable inlet valve per wheel brake, a first electrically actuable pressure source, and a second electrically actuable pressure source, wherein the first pressure source and the second pressure source are connected to a brake supply line, to which the at least four inlet valves are connected, and a pressure medium reservoir having a first reservoir chamber and a second reservoir chamber, wherein the first pressure source is hydraulically connected to the first reservoir chamber, and wherein the second pressure source is hydraulically connected to the second reservoir chamber. The pressure medium reservoir includes a third reservoir chamber and the first pressure source is connected via an electrically actuable first separation valve to the third reservoir chamber of the pressure medium reservoir.

### CROSS-REFERENCE TO RELATED APPLICATIONS

This application is a national stage application, filed under 35 U.S.C. § 371, of International Patent Application No. PCT/DE2022/200306, filed on Dec. 19, 2022, which claims priority to German patent application No. 10 2022 200 105.2, filed on Jan. 7, 2022, each of which is incorporated by reference.

### TECHNICAL FIELD

The technical field relates to a brake system for a motor vehicle.

### BACKGROUND

A brake system without a master brake cylinder and with two electrically controllable pressure sources for a motor vehicle with four hydraulically actuable wheel brakes is known from WO 2018/130483 A1. In addition to wheel-specific inlet and outlet valves, the brake system includes a circuit separation valve and three further separation valves. These components are arranged together in a single structural unit. In addition, two electronic open-loop and closed-loop control units are provided, wherein one of the electronic open-loop and closed-loop control units activates the second pressure source and the inlet and outlet valves, while the first pressure source and all of the other valves are activated by the other electronic open-loop and closed-loop control unit. The brake system comprises a pressure medium reservoir with two reservoir chambers, wherein the first pressure source is hydraulically connected to the first reservoir chamber for the replenishment of pressure medium and the second pressure source is hydraulically connected to the second reservoir chamber for the replenishment of pressure medium.

There remains an opportunity to provide an improved brake system which is suitable for highly automated driving and offers the extremely high availability required for highly automated driving. The brake system is intended to offer an improved service life/availability, in particular in the event of a leak in the parked state.

There also remains an opportunity to provide an improved brake system suitable for highly automated driving that, even in the event of a leak, offers such high availability that it manages without a driver-actuable hydraulic fall-back level, in particular without a mechanical-hydraulic connection from a driver-actuable actuating unit (e.g., a driver-actuable master brake cylinder) to the wheel brakes.

### SUMMARY

In one embodiment, a brake system includes one electrically actuable inlet valve per wheel brake, a first electrically actuable pressure source and a second electrically actuable pressure source, wherein the first pressure source and the second pressure source are connected to a brake supply line, to which the at least four inlet valves are connected, and a pressure medium reservoir having a first reservoir chamber and a second reservoir chamber, wherein the first pressure source is hydraulically connected to the first reservoir chamber, and wherein the second pressure source is hydraulically connected to the second reservoir chamber. The pressure medium reservoir comprises a third reservoir chamber and the first pressure source is connected via an electrically actuable first separation valve to the third reservoir chamber of the pressure medium reservoir.

The brake system affords the advantage that the first pressure source and thus the brake supply line or the wheel brakes can be depressurized via the connection to the first separation valve, but, in the event of a leak via said connection, only the third reservoir chamber runs empty and pressure medium can remain in the first and second reservoir chambers in order to ensure adequate braking of the motor vehicle at least for a predeterminable duration or distance.

The first separation valve may be normally open, and therefore, in a de-energized state of the brake system, the wheel brakes are connected to the third reservoir chamber via the first separation valve such that the wheel brakes are depressurized.

The first pressure source is advantageously hydraulically connected to the first reservoir chamber for the replenishment of pressure medium.

The first pressure source may be hydraulically connected to the first reservoir chamber via a non-return valve opening in the direction of the first pressure source. This is advantageously a spring-loaded non-return valve, as is known per se from WO 2018/130483 A1, for example. If necessary, pressure medium may be drawn from the first reservoir chamber into the first pressure source, but draining of the first reservoir chamber via the first pressure source is prevented. This connection of the first reservoir chamber to the first pressure source may be the only hydraulic attachment of the first reservoir chamber to the brake system and to the wheel brakes.

The second pressure source is advantageously hydraulically connected to the second reservoir chamber for the replenishment of pressure medium. A suction side of the second pressure source may be hydraulically connected to the second reservoir chamber. The second pressure source may be hydraulically connected on the suction side to the second reservoir chamber and on the pressure side to the brake supply line. The second pressure source may include one or more spring-loaded non-return valves, which are arranged in the hydraulic connection between the second reservoir chamber and the brake supply line.

The pressure medium reservoir may be under atmospheric pressure.

In one embodiment, no electrically actuable valve is arranged in the hydraulic connection between the second pressure source (or the suction side of the second pressure source) and the second reservoir chamber. Pressure medium is thus sucked in with little hydraulic resistance.

In one embodiment, no further electrically actuable valve in addition to the first separation valve is arranged in the hydraulic connection between the first pressure source and the third reservoir chamber. When the first separation valve is opened, the pressure between the wheel brakes and the pressure medium reservoir can thus be quickly equalized.

In one embodiment, the three reservoir chambers of the pressure medium reservoir are separated from each other by partition walls. Pressure medium reservoirs with separate reservoir chambers are known in principle, the separation of the chambers usually being realized by means of partition walls. In the event of an escape of pressure medium from one of the reservoir chambers via the associated reservoir port, a pressure medium reserve thus remains in the other two reservoir chambers.

In one embodiment, the three reservoir chambers and at least one overflow are arranged and designed such that an overflow of pressure medium from the third reservoir chamber is only possible (directly) into the first reservoir chamber (and not into the second reservoir chamber). When the circuit separation valve is closed, if the first and second brake circuits are separated, pressure medium can flow off into the third reservoir chamber via the opening first separation valve in the event of a pressure reduction by means of the first pressure source. Excess pressure medium is not then lost into the second reservoir chamber or into the brake circuit of the second pressure source. It is also possible to draw pressure medium from the first reservoir chamber with the first pressure source, with excess pressure medium volume then flowing off via the first separation valve into the “correct” brake circuit of the first pressure source.

In one embodiment, the third reservoir chamber is smaller than the first reservoir chamber and smaller than the second reservoir chamber. Thus, despite an additional third reservoir chamber, the pressure medium reservoir can be kept compact. By means of a corresponding small reduction in the size of the first and second reservoir chambers, the overall volume of the pressure medium reservoir can be maintained. A third reservoir chamber which is as small as possible is also advantageous for other reasons. In the event of a leakage point that is located significantly lower than the pressure medium reservoir, e.g., at one of the wheel brakes, the pressure difference could open the non-return valve to the first reservoir chamber and also drain the first reservoir chamber. The leakage from the first reservoir chamber ends as soon as air (from the drained third reservoir chamber) enters the system pressure line section through the first separation valve and the vacuum collapses.

In one embodiment, the brake system comprises one electrically actuable outlet valve per wheel brake, wherein the outlet valves are normally closed. Particularly preferably, the outlet valves are connected to the second reservoir chamber, as well as the second pressure source. Particularly preferably, all of the outlet valves are connected via a common hydraulic connection to the second reservoir chamber of the pressure medium reservoir.

In one embodiment, a non-return valve opening in the direction of the first pressure source is connected in parallel to the first separation valve.

In one embodiment, an electrically actuable circuit separation valve is arranged in the brake supply line in such a manner that, when the circuit separation valve is closed, the brake supply line is hydraulically separated into a first line section and a second line section, wherein the first line section is hydraulically connected to the second pressure source and to at least two of the at least four inlet valves, and the second line section is hydraulically connected to the first pressure source and to the other inlet valves of the at least four inlet valves. The second line section may be hydraulically connected to the first pressure source and to the other at least two of the at least four inlet valves.

The circuit separation valve may be normally open, and therefore the circuit separation valve does not have to be activated by means of one of the pressure sources in order to actuate (all of) the wheel brakes.

In one embodiment, the first pressure source is connected to the brake supply line via an electrically actuable second separation valve. By closing of the second separation valve, the first pressure source (or the first structural unit) can be hydraulically separated from the brake supply line, e.g. if the brake system is intended to be or has to be operated in an operating mode (e.g. in the event of an electrical failure of the first structural unit) in which the at least four wheel brakes are pressurized by means of the second pressure source. The second separation valve may be normally open. In a de-energized state of the brake system, the wheel brakes are thus connected to the third reservoir chamber via the second separation valve and the first separation valve and depressurized.

In one embodiment, the first pressure source is connected via a system pressure line section to the second separation valve, the system pressure line section being connected via the first separation valve to the third reservoir chamber of the pressure medium reservoir.

In one embodiment, the brake system includes at least four wheel ports for the at least four wheel brakes and, in a de-energized state of the brake system, the first reservoir chamber and the second reservoir chamber are each hydraulically separated from the wheel ports. The first and second reservoir chambers thus cannot be drained when the brake system is switched off (e.g., when the vehicle is parked) and there is a leak in one of the wheel brake lines (e.g., between the wheel port and the wheel brake).

In one embodiment, the first reservoir chamber is hydraulically connected to the at least four wheel ports only via the first pressure source, the first reservoir chamber being hydraulically connected to the first pressure source via a spring-loaded non-return valve opening in the direction of the first pressure source. Thus, if necessary, pressure medium can be drawn from the first reservoir chamber into the first pressure source, in order to then convey the pressure medium to the wheel ports (or into the wheel brakes) by means of the first pressure source, but the first reservoir chamber is prevented from being drained via the first pressure source.

In one embodiment, the second reservoir chamber is hydraulically connected to the at least four wheel ports via the normally closed outlet valves. The second reservoir chamber is furthermore hydraulically connected to the at least four wheel ports via the second pressure source, the second pressure source including at least one spring-loaded non-return valve opening in the direction of the wheel ports, and therefore the second reservoir chamber is hydraulically connected to the at least four wheel ports via the spring-loaded non-return valve or valves of the second pressure source. A further (third) hydraulic connection between the second reservoir chamber and the at least four wheel ports is particularly preferably not present. Thus, if necessary, pressure medium can be drawn from the second reservoir chamber by means of the second pressure source and conveyed to the wheel ports (or into the wheel brakes). And, if necessary, pressure medium can be discharged into the second reservoir chamber by means of the outlet valves. However, draining of the second reservoir chamber is prevented when the brake system is de-energized.

In one embodiment, the first pressure source and its connection to the first reservoir chamber is designed such that, in a de-energized state of the brake system, there is no hydraulic connection between the first reservoir chamber and the wheel ports of the brake system or the wheel brakes, via which pressure medium can flow off from the first reservoir chamber into one of the wheel brakes.

In one embodiment, the brake system is designed such that, in a de-energized state of the brake system, there is no hydraulic connection between the first reservoir chamber and the wheel ports of the brake system or the wheel brakes, via which pressure medium can flow off from the first reservoir chamber into one of the wheel brakes.

In one embodiment, the second pressure source and its connection to the second reservoir chamber is designed such that, in a de-energized state of the brake system, there is no hydraulic connection between the second reservoir chamber and the wheel ports of the brake system or the wheel brakes, via which pressure medium can flow off from the second reservoir chamber into one of the wheel brakes.

In one embodiment, the brake system is designed such that, in a de-energized state of the brake system, there is no hydraulic connection between the second reservoir chamber and the wheel ports of the brake system or the wheel brakes, via which pressure medium can flow off from the second reservoir chamber into one of the wheel brakes.

According to one embodiment, the second pressure source is of dual-circuit or multi-circuit design. The second pressure source is particularly preferably designed as a dual-piston pump or multi-piston pump.

The pressure sides of the dual-circuit or multi-circuit pressure source may be interconnected (e.g., to form a common pressure port) and the suction sides of the dual-circuit or multi-circuit pressure source are interconnected (to form a common suction port).

The suction side (or the suction port) of the second pressure source may be connected together with the outlet valves to the second reservoir chamber of the pressure medium reservoir.

The pressure side (or the pressure port) of the second pressure source may be connected to the first line section of the brake supply line.

The first pressure source may be formed by a cylinder-piston arrangement with a hydraulic pressure chamber, the piston of which is advanced for a build-up of brake pressure, and is retracted for a dissipation of brake pressure, by an electromechanical actuator.

The first pressure source may be formed by a cylinder-piston arrangement with a hydraulic pressure chamber, a suction port, and a pressure port, the piston of which is advanced and retracted by an electromechanical actuator. The suction port is advantageously connected via the non-return valve opening in the direction of the first pressure source to the first reservoir chamber of the pressure medium reservoir. The pressure port is advantageously connected to the brake supply line, in particular to the second line section. The pressure port my additionally be connected to the third reservoir chamber of the pressure medium reservoir via the first separation valve.

In one embodiment, the brake system includes a first electronic control device, which activates the first pressure source, and a second electronic control device, which activates the second pressure source and the inlet valves, and in particular the outlet valves.

According to one embodiment, the brake system comprises a first structural unit, in which the first electrically actuable pressure source is arranged, and a second structural unit, in which the second electrically actuable pressure source and the electrically actuable inlet valves are arranged, wherein the pressure medium reservoir is arranged on the first structural unit. Particularly preferably, the outlet valves are arranged in the second structural unit.

In one embodiment, the first structural unit and the second structural unit are connected to one another by at most one pressure-resistant hydraulic connecting element.

Other non-pressure-resistant connecting elements are possible between the first and second structural units.

A pressure-resistant connecting element or a pressure-resistant attachment/connection is preferably understood to mean that the connecting element or the attachment/connection is configured for a maximum operating pressure of one of the pressure sources, in particular the first pressure source, and/or the wheel brakes. The pressure-resistant connecting element or the pressure-resistant attachment/connection is particularly preferably configured for a pressure of about 180-220 bar. The pressure-resistant connecting element or the pressure-resistant attachment/connection is very particularly preferably configured for a pressure of about 200 bar.

A non-pressure-resistant connecting element or a non-pressure-resistant attachment/connection is preferably understood to mean that the connecting element or the attachment/connection is not designed for the maximum operating pressure of the wheel brakes. A non-pressure-resistant connecting element or a non-pressure-resistant attachment/connection is particularly preferably configured for a maximum pressure of about 10 bar.

The first structural unit and the second structural unit may be designed such that they are connected to one another by at most one pressure-resistant hydraulic connecting element. The first structural unit and the second structural unit may be connected to one another by a plurality of hydraulic connecting elements, but at most one—in the sense of only one—of these hydraulic connecting elements is designed to be pressure-resistant. Any other hydraulic connecting elements are not designed to be pressure-resistant.

The first structural unit and the second structural unit may be connected to one other by only one hydraulic connecting element, wherein this connecting element is designed to be pressure-resistant, that is to say is the pressure-resistant hydraulic connecting element. Further, non-pressure-resistant connecting elements, advantageously between the second structural unit and the pressure medium reservoir, are possible.

In one embodiment, the first separation valve is arranged in the first structural unit.

In one embodiment, the outlet valves are arranged in the second structural unit.

The circuit separation valve may be arranged in the second structural unit.

The second separation valve may be arranged in the second structural unit.

A division into two structural units affords the advantage that both structural units are smaller and lighter and therefore easier to handle compared to implementation in only one structural unit. They can also be manufactured more easily in existing production plants. On the other hand, when divided into two structural units, each hydraulic connection between these structural units leads to considerable effort and costs. It is therefore particularly advantageous to keep the number of hydraulic connections as low as possible. It has been shown that it is advantageous to separate the various functions of hydraulic connections as clearly as possible. This means that connections via which pressure medium is drawn in can be designed with the largest possible diameter so that they have the smallest possible hydraulic resistance. For this, it is advantageous if such connections do not have to be pressure-resistant. Conversely, pressure-bearing connections should not have a suction function.

In one embodiment, the first structural unit includes a first electronic control device, which activates the first pressure source, and the second structural unit comprises a second electronic control device, which activates the second pressure source and the inlet valves (and optionally the outlet valves).

In one embodiment, the first structural unit includes a first hydraulic port for connection to the first pressure medium reservoir, a third hydraulic port for connection to the third reservoir chamber, and a second hydraulic port for connection to the second structural unit, the second hydraulic port being connected to the hydraulic connecting element. In this embodiment, the first structural unit does not include a further hydraulic port in addition to the first hydraulic port, the second hydraulic port and the third hydraulic port.

The first pressure source may be connected to the second hydraulic port in order to be able to actuate the at least four wheel brakes.

The second structural unit may include at least four hydraulic wheel ports for connection to the wheel brakes, a first hydraulic port for connection to the second reservoir chamber, and a second hydraulic port for connection to the first structural unit, the second hydraulic port being connected to the hydraulic connecting element. In this embodiment, the second structural unit does not include a further hydraulic port, in addition to the first hydraulic port, the second hydraulic port and the at least four hydraulic wheel ports.

In one embodiment, the first separation valve is activated by the first electronic control device.

In one embodiment, the circuit separation valve is activated by the second electronic control device.

In one embodiment, the second separation valve is activated by the second electronic control device.

In one embodiment, the brake system includes a first electrical partition and a second electrical partition, which are electrically independent of each other. The first pressure source and the first electronic control device are assigned to the first electrical partition, and the second pressure source, the second electronic control device and the inlet valves are assigned to the second electrical partition. In this embodiment, the outlet valves and the circuit separation valve are assigned to the second electrical partition. Further, the first separation valve is assigned to the first electrical partition. Moreover, the second separation valve is assigned to the second electrical partition.

The first electronic control device or the first electrical partition may be supplied with power by a first electrical energy source and the second electronic control device or the second electrical partition may be supplied with power by a second electrical energy source which is independent of the first electrical energy source. The first energy source is thus part of the first electrical partition, and the second energy source is part of the second electrical partition.

In one embodiment, the first pressure source is activated exclusively by the first electronic control device and the second pressure source, the inlet and outlet valves and the circuit separation valve are activated exclusively by the second electronic control device. In this embodiment, the first separation valve is activated exclusively by the first electronic control device and the second separation valve is activated exclusively by the second electronic control device.

The brake system described herein affords the advantage that the choice and arrangement of the electrically actuable valves, in particular the electronic partitioning and in particular the assignment between electrically actuable valves and electronic control devices allows a clear separation between the properties of the hydraulic connections.

The brake system may include at least four hydraulically actuable wheel brakes.

In one embodiment, the brake system for each wheel brake comprises an inlet valve and an outlet valve for adjusting wheel-specific brake pressures, which are derived from the brake supply pressure in the brake supply line, wherein, in the non-activated state, the inlet valves pass the brake supply pressure to the wheel brakes and the outlet valves block a flow of pressure medium from the wheel brakes.

In one embodiment, in addition to the first and second pressure sources, the brake system does not include any further pressure source for building up a brake pressure for actuating the wheel brakes. The brake system may include neither a further electrically actuable pressure source nor a driver-actuable pressure source, such as a master brake cylinder, which is operatively connected, for example hydraulically or mechanically connected, to at least one of the wheel brakes for actuation thereof.

In one embodiment, the brake system comprises an actuating unit for a vehicle driver, wherein the actuating unit is connected to at least one electronic control device for transmitting a driver's demand signal and wherein there is no mechanical-hydraulic connection from the actuating unit to the wheel brakes.

The brake system affords the advantage that, even in the event of a failure of one of the two redundant electrical pressure sources, for example due to a failure of the electrical energy source assigned thereto or of the electronic control device assigned thereto or a mechanical fault or a leak in one of the two brake circuits, the most important residual braking functions can be maintained over a required time and/or travel distance.

The brake system is therefore particularly suitable for the realization of highly automated driving functions and for use with an electric brake pedal, which has no mechanical-hydraulic connection to the wheel brakes.

### BRIEF DESCRIPTION OF THE DRAWINGS

Further embodiments of the invention are derived from the dependent claims and the following description with reference to figures, in which, schematically:

FIG. 1 shows a first exemplary embodiment of a brake system, and

FIG. 2 shows a second exemplary embodiment of a brake system.

### DETAILED DESCRIPTION

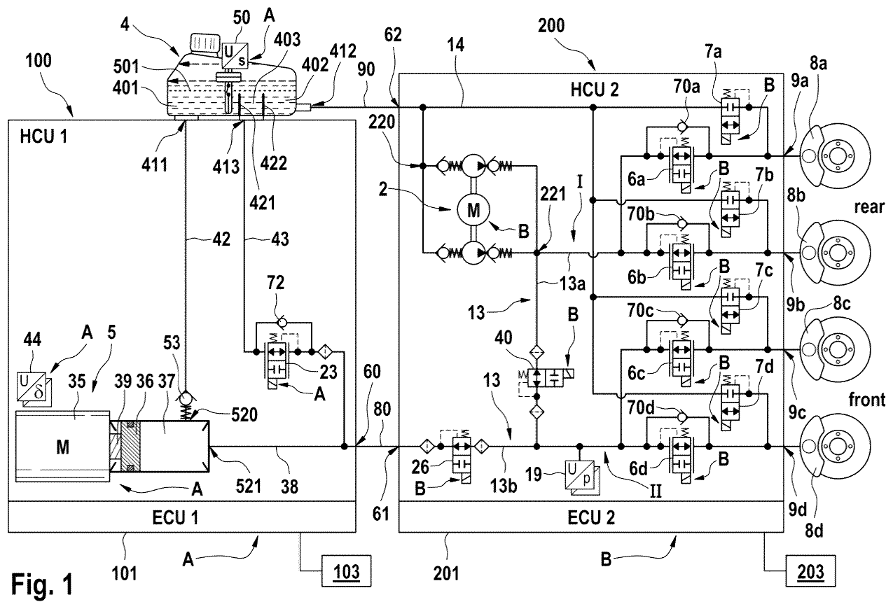

FIG. 1 highly schematically illustrates a first exemplary embodiment of a brake system for a motor vehicle. According to the example, the brake system is designed for actuating four hydraulically actuable wheel brakes 8a-8d; an extension to more wheel brakes is easily possible. According to the example, the wheel brakes 8a, 8b are assigned to the rear axle (rear) and the wheel brakes 8c, 8d are assigned to the front axle (front) of the vehicle.

The brake system includes a first electrically actuable pressure source 5 and a second electrically actuable pressure source 2. To actuate the wheel brakes 8a-8d, the first pressure source 5 and the second pressure source 2 (on the pressure side) are connected to a brake supply line 13, to which the four wheel brakes 8a-8d are connected via a respective inlet valve 6a-6d. All four wheel brakes 8a-8d can thus be actuated by means of the first pressure source 5 or by means of the second pressure source 2.

The brake system includes a pressure medium reservoir 4 with three reservoir chambers 401, 402, 403. The first reservoir chamber 401 is assigned to the first pressure source 5 and the second reservoir chamber 402 is assigned to the second pressure source 2. For the replenishment of pressure medium, the first pressure source 5 (on the suction side) is correspondingly hydraulically connected to the first reservoir chamber 401 via a non-return valve 53 closing in the direction of the first reservoir chamber 401. For the replenishment of pressure medium, the second pressure source 2 (on the suction side) is hydraulically connected directly to the second reservoir chamber 402. The third, separate reservoir chamber 403 is provided to be able to perform a pressure equalization of the wheel brakes 8a-8d if necessary, i.e. in particular the wheel brakes 8a-8d can be depressurized. For this purpose, the first pressure source 5, and thus also the brake supply line 13 to the wheel brakes 8a-8d, is separably connected to the third reservoir chamber 403 via an electrically actuable separation valve 23.

Advantageously, the first electrically controllable pressure source 5 is designed as a hydraulic cylinder-piston arrangement (or an electro-hydraulic actuator (linear actuator)).

Advantageously, the second electrically controllable pressure source 2 is designed as a piston pump, for example as a dual-piston pump, the two pressure sides of which are interconnected and the two suction sides of which are interconnected.

Advantageously arranged in the brake supply line 13 is an electrically actuable circuit separation valve 40, and therefore, when the circuit separation valve 40 is closed, the brake supply line 13 is separated into a first line section 13a, to which the inlet valves 6a, 6b and the wheel brakes 8a, 8b are connected, and a second line section 13b, to which the inlet valves 6c, 6d and the wheel brakes 8c, 8d are connected. The second pressure source 2 is hydraulically connected to the first line section 13a, and the first pressure source 5 is hydraulically connected to the second line section 13b. When the circuit separation valve 40 is closed, the brake system is thus separated or divided into two hydraulic brake circuits I and II. Here, in the first brake circuit I, the pressure source 2 is connected to only the wheel brakes 8a and 8b (via the first line section 13a) and, in the second brake circuit II, the first pressure source 5 is connected to only the wheel brakes 8c and 8d (via the second line section 13b). The circuit separation valve 40 is advantageously designed to be normally open.

In addition to the electrically actuable, advantageously normally open, inlet valve 6a-6d, one electrically actuable, advantageously normally closed, outlet valve 7a-7d is provided per wheel brake 8a-8d.

As already mentioned, the brake system includes the pressure medium reservoir 4, advantageously under atmospheric pressure, with three reservoir chambers 401, 402, 403. In this case, the first chamber 401 is assigned a first reservoir port 411, the second chamber 402 a second reservoir port 412 and the third chamber 403 a third reservoir port 413. The first reservoir chamber 401 is assigned to the first pressure source 5 and the second reservoir chamber 402 is assigned to the second pressure source 2. For the replenishment of pressure medium, the first pressure source 5 (on the suction side, for example via a suction port 520 and a (replenishment) line 42) is hydraulically connected to the first reservoir chamber 401. A non-return valve 53 closing in the direction of the first reservoir chamber 401 of the pressure medium reservoir 4 is arranged in the (replenishment) line 42. For the replenishment of pressure medium, the second pressure source 2 (on the suction side, for example via a suction port 220, a line 14 and a tube 90) is hydraulically connected directly to the second reservoir chamber 402.

The third, separate reservoir chamber 403 is provided to be able to perform a pressure equalization of the wheel brakes 8a-8d if necessary, i.e. in particular the wheel brakes 8a-8d can be depressurized. For this purpose, the first pressure source 5, and thus also the brake supply line 13 to the wheel brakes 8a-8d, is separably connected to the third reservoir chamber 403 via an electrically actuable, advantageously normally open, separation valve 23.

Thus, by means of the separation valve 23, the first pressure source 5 can be depressurized or the wheel brakes 8a-8d are depressurized in the de-energized state of the brake system.

Pressure medium reservoir 4 is divided into three reservoir chambers 401, 402, 403 by two partition walls, for example. For example, the pressure medium reservoir 4 comprises a first partition wall 421 and a second partition wall 422, wherein the first reservoir chamber 401 is separated from the third reservoir chamber 403 by the first partition wall 421, and the third reservoir chamber 403 is separated from the second reservoir chamber 402 by the second partition wall 422. A different sequence of the reservoir chambers or a different relative arrangement of the three reservoir chambers is possible. In principle, the pressure medium reservoir 4 may also have more than three reservoir chambers; however, this is associated with higher production costs.

The third reservoir chamber 403 of the pressure medium reservoir 4 can be very small in size (the third reservoir chamber 403 is smaller than the first reservoir chamber 401 and smaller than the second reservoir chamber 402). The installation space for the pressure medium reservoir 4 can be selected to be precisely the same size as for a known pressure medium reservoir 4 with two chambers, i.e., the pressure medium reservoir 4 is not increased in size.

The three reservoir chambers 401, 402, 403 and at least one overflow between them are arranged and designed such that a (direct) overflow of pressure medium from the third reservoir chamber 403 is only possible into the first reservoir chamber 401, and not into the second reservoir chamber 402.

Advantageously, the brake system, for leakage monitoring, includes a level measuring device 50 for detecting or determining a pressure medium level of the pressure medium reservoir 4. The level measuring device 50 is designed even to detect levels of the pressure medium in the pressure medium reservoir 4 that are located above the partition walls 421, 422. For example, the level measuring device 50 identifies a too low pressure medium level, and closes in particular the circuit separation valve 40 when the pressure medium level falls below the limit level 501. The limit level 501 lies above the partition walls 421, 422.

As an example, the level measuring device 50 is arranged in the first reservoir chamber 401. Positioning of the level measuring device 50 in that reservoir chamber (401) which is assigned to the pressure source, which is designed as a hydraulic cylinder-piston arrangement (linear actuator) (first pressure source 5), affords the advantage of faster identification of a pressure medium loss. In the event of an external leak, the linear actuator would very quickly pump pressure medium outward during braking and the pressure medium then flows at a limited speed within the pressure medium reservoir 4 (especially in cold weather). In order to be able to report the pressure medium loss quickly, it is therefore advantageous to place the level measuring device 50 close to the point at which a large outflow can be expected, i.e. in the reservoir chamber 401 assigned to the first pressure source 5 (linear actuator).

The brake system includes, for example, a first structural unit 100, which is designed, for example, as a first electrohydraulic brake control unit (HECU1) with a valve block HCU1 and a first electronic control device 101 (ECU1), and a second structural unit 200, which is designed, for example, as a second electrohydraulic brake control unit (HECU2) with a valve block HCU2 and a second electronic control device 201 (ECU2).

The first electrically actuable pressure source 5 is arranged in the first structural unit 100.

The second electrically actuable pressure source 2 and the wheel-specific brake pressure modulation valves (inlet valves 6a-6d and outlet valves 7a-7d) are arranged in the second structural unit 200.

The pressure medium reservoir 4 is arranged, for example, on the first structural unit 100.

As already mentioned, the brake system includes, for each hydraulically actuable wheel brake 8a-8d, an inlet valve 6a-6d and an outlet valve 7a-7d which are hydraulically interconnected in pairs via central ports and are each connected to a hydraulic wheel port 9a-9d of the second structural unit 200, to which the corresponding wheel brake 8a-8d is connected. A non-return valve 70a-70d which opens in the direction of the brake supply line 13 is connected in parallel with each of the inlet valves 6a-6d. The output ports of the outlet valves 7a-7d are connected via a common line 14 to a hydraulic port 62 of the second structural unit 200, which port is connected to the pressure medium reservoir 4 or to its reservoir chamber 402. The input ports of all of the inlet valves 6a-6d can be supplied by the brake supply line 13 (when the circuit separation valve 40 is open) with a pressure which is provided by the first pressure source 5 or, for example in the event of a failure of the first pressure source 5, by the second pressure source 2.

The first electrically controllable pressure source 5 of the valve block HCU1 is in the form of a hydraulic cylinder-piston arrangement (or a single-circuit electrohydraulic actuator (linear actuator)), the piston 36 of which can be actuated, in particular advanced and retracted, in order to build up and dissipate a pressure in a pressure chamber 37, by a schematically indicated electric motor 35 with the interconnection of a likewise schematically illustrated rotation-translation mechanism 39. The piston 36 delimits the pressure chamber 37 of the pressure source 5. For the activation of the electric motor 35, a rotor position sensor 44 is provided, which detects the rotor position of the electric motor 35 and which is merely schematically indicated.

A system pressure line section 38 is connected to the pressure chamber 37 of the first electrically controllable pressure source 5. By means of line section 38, pressure source 5 or pressure chamber 37 is connected to a hydraulic port 60 of the first structural unit 100, which is connected via a hydraulic connecting element 80 to a hydraulic port 61 of the second structural unit 200. Connection 80 is the only hydraulic pressure connection, in particular the only hydraulic connection, between the first and the second structural unit. It is a hydraulic connection for transmitting a brake pressure to actuate the wheel brakes 8a-8d. Connecting element 80 therefore has to be pressure-resistant.

Pressure chamber 37 is connected, regardless of the actuating state of the piston 36, via the (replenishment) line 42 to the first reservoir port 411 of the pressure medium reservoir 4, and thus to the reservoir chamber 401. The non-return valve 53 closing in the direction of the pressure medium reservoir 4 is arranged in the line 42. The cylinder-piston arrangement 5, for example, does not have any snifter bores.

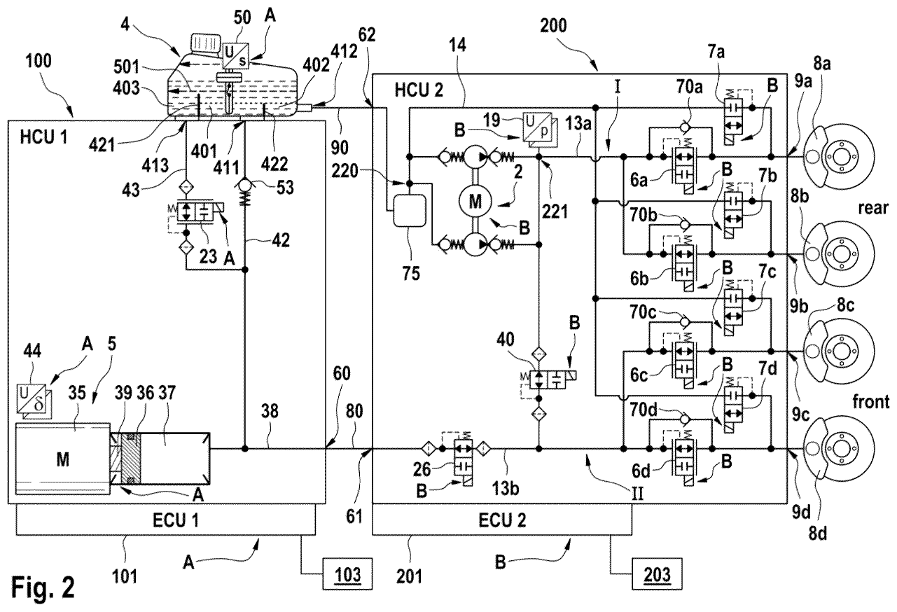

Furthermore, the pressure chamber 37 of the first pressure source 5 is connected, for example via the line section 38, the separation valve 23 and a line 43, to the third reservoir port 413 of the pressure medium reservoir 4, and thus to the reservoir chamber 403. For example, a non-return valve 72 opening in the direction of the pressure chamber 37 is connected in parallel with the separation valve 23. However, such a non-return valve 72 is functionally unnecessary (see also in the second exemplary embodiment of FIG. 2).

In addition to the two (pressure-free) ports to the reservoir chambers 401, 403 and the (pressure) port 60, the first structural unit 100 does not comprise any other hydraulic ports.

According to the example, the second electrically controllable pressure source 2 is designed as a dual-piston pump, the two pressure sides of which are interconnected (pressure port 221) and the two suction sides of which are interconnected (suction port 220). The suction sides (suction port 220) are connected to the line 14 and thus to the port 62 or 412, and therefore to the second reservoir chamber 402. The pressure sides (pressure port 221) are connected to the first line section 13a of the brake supply line 13.

According to the example, an electrically actuable, advantageously normally open, separation valve 26 is arranged in the second structural unit 200 in addition to the pressure source 2 and the brake pressure modulation valves 6a-6d, 7a-7d. Separation valve 26 is arranged hydraulically between the first pressure source 5, specifically the port 61, and the second line section 13b of the brake supply line 13. Thus, the first pressure source 5 is separably connected to the second line section 13b or the brake supply line 13 via the separation valve 26.

According to the example, the brake system comprises, in the brake circuit II (line section 13b), a pressure sensor 19, which is thus assigned to the pressure source 5. However, pressure sensor 19 may also be arranged in the brake circuit I (see exemplary embodiment of FIG. 2) or a second pressure sensor may be provided, such that each of the two brake circuits I and II can be directly monitored by means of a pressure sensor.

According to the example, the components 5, 53, 23, 72 and the line sections 38, 42, 43 are arranged in the first valve block HCU1 and the components 2, 40, 6a-6d, 7a-7d, 26, 19 and the line sections 13a, 13b (and the line sections between the inlet and outlet valves, on the one hand, and the wheel ports, on the other hand) are arranged in the second valve block HCU2.

Each valve block HCU1, HCU2 is assigned an electronic control device 101, 201 (ECU1, ECU2). Each electronic control device 101, 201 comprises electrical and/or electronic elements (for example, microcontrol devices, power modules, valve drivers, other electronic components, etc.) for activating the electrically actuable components of the associated valve block and optionally the assigned sensors. The valve block and electronic control device are advantageously designed in a known manner as an electrohydraulic unit (HECU).

For the electrical attachment, connection and supply of the individual electrical or electrically actuable, activatable, evaluatable or similar components of the brake system, a first electrical partition A and a second electrical partition B are provided, which are electrically independent of one another.

In the figure, those electrical components which are assigned or belong to the first electrical partition A are indicated by an arrow A, while those electrical components which are assigned or belong to the second electrical partition B are indicated by an arrow B.

The electronic control device 101 is assigned to or belongs to the first electrical partition A, while the second electronic control device 201 is assigned to or belongs to the second electrical partition B. Accordingly, the electronic control device 101 and the second electronic control device 201 are electrically independent.

To supply the brake system with electrical energy, a first electrical energy source 103, for example a vehicle electrical system, and a second electrical energy source 203, for example a vehicle electrical system, which is independent of the first energy source, are provided. The first electrical energy source 103 supplies the first electrical partition A with energy and the second electrical energy source 203 supplies the second electrical partition B.

The first electronic control device 101 activates the first pressure source 5. Accordingly, the first pressure source 5 is assigned to or associated with the first electrical partition A. According to the example, the first pressure source 5 is supplied with energy (from the first electrical energy source 103) via the first electronic control device 101.

The second electronic control device 201 activates the second pressure source 2. Accordingly, the second pressure source 2 is assigned to or associated with the second electrical partition B. According to the example, the second pressure source 2 is supplied with energy (from the second electrical energy source 203) via the second electronic control device 201.

According to the example, the first pressure source 5 can be or is activated exclusively by the first electronic control device 101, and the second pressure source 2 can be or is activated exclusively by the second electronic control device 201. It would basically be conceivable for the electric motor of a pressure source to be equipped for example with two electrically independent motor coils; it would thus be possible for the pressure source to be activated by the two independent electrical devices. This would however be associated with further redundancies, for example double connecting lines, etc., and would thus be more expensive.

The remaining components of the brake system are advantageously assigned to either the first electronic control device 101 (partition A) or the second electronic control device 201 (partition B). That is to say, the components are activated or actuated by the control device and/or supplied with electrical energy by the control device, and/or are connected on the signal side to the control device and/or are evaluated by the control device. In order to avoid further redundancies, it is advantageously the case that a component is activatable or actuable by, or suppliable with electrical energy by, or connected on the signal side to, or evaluatable by, only or exclusively one of the two electronic control devices 101, 201, but not the other electronic control device.

The inlet and outlet valves 6a-6d, 7a-7d are assigned to the second electrical partition B and are activated by the second electronic control device 201. The circuit separation valve 40 is likewise assigned to the second electrical partition B and is activated by the second electronic control device 201.

The separation valve 26 for the separation of the first pressure source 5 and the brake supply line 13 is also assigned to the second electrical partition B and is activated by the second electronic control device 201.

Pressure sensor 19 is also assigned to the second electrical partition B. The signals from said sensor are fed to the second electronic control device 201 and evaluated and processed by the latter.

The separation valve 23, on the other hand, is assigned to the first electrical partition A and is activated by the first electronic control device 101.

Furthermore, the signals from the level measuring device 50 are supplied to the first electronic control device 101 and evaluated and processed by the latter.

The suction side 220 of the pressure source 2 is connected via port 62 and a line or a tube 90 directly, without intermediate connection of an electrically actuable valve, to the second reservoir chamber 402 of the pressure medium reservoir 4. The connection 90 does not carry any pressure and may therefore have a large diameter.

The pressure side 221 of the pressure source 2 is directly connected to the first line section 13a without the intermediate connection of a valve.

The pressure port 521 of the pressure source 5 is connected via the separation valve 23, also called pressure relief valve, to the pressure medium reservoir 4, especially the third reservoir chamber 403.

In one embodiment, separation valve 26, circuit separation valve 40 and separation valve 23 are normally open.

In normal operation, the pressure in the wheel brakes is built up by the pressure source 5 with the separation valve 23 closed. The pressure is dissipated into the pressure source 5 or via the separation valve 23. The pressure is modulated by the inlet and outlet valves 6a-6d, 7a-7d wheel-specifically as required. If necessary, the separation valve 26 is closed so that the pressure source 5 can draw in additional volume, e.g., from the first reservoir chamber 401.

If a particularly high volume flow rate is requested, both pressure sources 5 and 2 operate simultaneously in parallel. In this case, the pressure is dissipated at least partially via the separation valve 23, which may be designed as an analog valve, that is to say it can control its flow. The pressure dissipation, which cannot take place via the first pressure source 5 (so-called excess pressure medium volume), can be carried out either via the separation valve 23 or via the outlet valves, preferably via the outlet valves 7a, 7b on the rear axle (rear). If a particularly high pressure is requested, the separation valve 26 is closed, and the pressure source 2 increases the pressure beyond the pressure of the pressure source 5. Outside of braking operations, atmospheric pressure equalization is permanently ensured via separation valve 23 and separation valve 26.

In the event of a leak in the brake system, the circuit separation valve 40 is advantageously closed and the system is thus divided into two independent brake circuits I and II.

The separation valve 23 may be activated by the primary ECU 101. The separation valve 26 may be activated by the secondary ECU 201. The following description of operation in the event of a fault refers to this valve assignment.

If the primary system fails electrically, in particular the primary ECU 101 or the power supply 103 thereof (partition A failure), the secondary ECU 201 closes the separation valve 26 to build up pressure via the secondary pressure source 2. Pressure is dissipated via the separation valve 26 or via the outlet valves 7a-7d. The inlet and outlet valves are preferably activated by the secondary ECU 201 (partition B), so that the pressure can be modulated wheel-specifically.

If the secondary system fails electrically, in particular the secondary ECU 201 or the power supply 203 thereof (partition B failure), the pressure is built up and dissipated as in normal operation via the primary pressure source 5 and, if necessary, the separation valve 23. Wheel-specific pressure control has to be given up, but joint modulation of the wheel pressures remains possible in order to prevent the vehicle from being destabilized by wheel-locking.

In one embodiment, the assignment of the valves to the two ECUs is as described above, the circuit separation valve 40 is activated by the secondary ECU 201, and the system is divided into two units 100, 4 and 200 with two hydraulic connecting lines 80 (pressure-resistant) and 90 (pressure-free). These two units may each include one of the two ECUs, the assigned pressure source and the assigned valves.

The division of the exemplary brake systems into two structural units affords the advantage that both structural units are smaller and lighter and therefore easier to handle compared to implementation in only one structural unit. They can also be manufactured more easily in existing production plants. When divided into two structural units, each hydraulic connection between these structural units will result in additional effort and additional costs. It is therefore advantageous to keep the number of hydraulic connections as low as possible. It is furthermore advantageous to separate the various functions of hydraulic connections as clearly as possible. Connections via which pressure medium is drawn in should have as little hydraulic resistance as possible and therefore as large a diameter as possible. For this, it is advantageous if such connections do not have to be pressure-resistant. Conversely, pressure-bearing connections should not have a suction function.

The choice and arrangement of the electrically actuable valves, the electronic partitioning and in particular the assignment between electrically actuable valves and electronic control devices enable these advantageous properties of the hydraulic connections of the two structural units. It is made possible for the two structural units to need only one pressure-resistant connection apart from the depressurized connections to the pressure medium reservoir.

A special advantage of the exemplary brake system with a pressure medium reservoir 4 with at least three reservoir chambers 401, 402, 403 will be explained below.

Basically, a brake system is conceivable, which corresponds to the brake system of FIG. 1 with the difference that the pressure medium reservoir 4 (only) comprises the two reservoir chambers 401, 402 and the separation valve 23 is connected on the pressure medium reservoir side to the line 42 or the first reservoir chamber 401. That is to say that the pressure chamber 37 of the first pressure source 5 is connected to the same reservoir chamber 401 via a parallel connection of non-return valve 53 and separation valve 23 (optionally with non-return valve 72). This brake system has the disadvantage that, in the event of a leak at the rear axle (rear) in the switched off (de-energized) state of the brake system, the reservoir chamber 401 of the pressure medium reservoir 4 would drain. When starting the brake system, the low pressure medium level in the pressure medium reservoir could then be detected via the level measuring device 50 and the circuit separation valve 40 could be closed to separate the circuit. The rear axle circuit I (incl. reservoir chamber 402) would be empty after a few braking maneuvers due to the leak at the rear axle (rear) and would fail. At the front axle (front), only the pressure medium volume in the pressure chamber 37 of the first pressure source 5 is then available; the reservoir chamber 401 is already empty. With each braking operation, a small volume of pressure medium is lost in the defective rear axle circuit I via the usually unavoidable leakage of circuit separation valve 40 and the two outlet valves 7c, 7d. After a number of braking operations, the achievable braking effect of the front axle circuit II is thus continuously reduced until it fails. A required operating time (or travel distance) of the brake system after leakage in the parked state is thus not achieved, depending on the leakage conductance of the outlet valves and the circuit separation valve.

The disadvantage described is eliminated by the brake system described herein.

In this case, the pressure medium reservoir 4 includes an additional third reservoir chamber 403, which is separated, for example, by at least one partition wall from the first and the second reservoir chamber 401, 402, wherein the first pressure source 5 or the brake supply line 13 or the second line section 13b is connected to the third reservoir chamber 403 via the electrically actuable separation valve 23.

Thus, the pressure equalization of the wheel brakes to the atmosphere is realized via the separation valve 23 and a dedicated (separate third) reservoir chamber 403 in the pressure medium reservoir 4.

In the case of a leak at the rear axle (rear) when the vehicle is switched off (parked), only the third reservoir chamber 403 drains in the brake system according to the example. In the brake system according to the example, the two main chambers (first and second reservoir chambers 401, 402) are separated from the wheel brake lines (wheel ports 9a-9d) by means of (spring-loaded) non-return valves or normally closed switching valves and therefore cannot drain. When starting the brake system, the low pressure medium level in the pressure medium reservoir 4 is detected by means of the level measuring device 50 and the circuit separation valve 40 is closed to separate the circuit. The rear axle circuit I becomes empty after a few braking maneuvers due to the leak at the rear axle (rear) and will fail. On the front axle (front), the pressure medium volume is available in the pressure chamber 37 of the first pressure source 5 and the pressure medium volume of the first reservoir chamber 401 is available via circuit separation valve 40 and outlet valves to compensate for leakage in the defective rear axle brake circuit I. If the pressure medium reservoir 4 is dimensioned accordingly, further operation over the required time and travel distance can thus be ensured.

The third reservoir chamber 403 of the reservoir 4 can be dimensioned to be very small. The installation space for the reservoir 4 is not increased or is not significantly increased.

In the event of a leak, full dual-circuit operation with reserve volume in the reservoir 4 is possible immediately after closing the circuit separation valve 40. No leak search routines and conditioning routines are required.

The duration of the dual-circuit operation is limited only by the leaks of the circuit separation and outlet valves and the chamber volume of the corresponding reservoir chamber 401 or 402. Depending on the location of the leak (e.g. 8a, 8b, 8c, 8d), the reservoir chamber (401 or 402), which is connected to the leak point after closing the circuit separation valve 40, is quickly emptied. The other reservoir chamber (402 or 401) remains full. However, a small volume of pressure medium is lost during each braking operation due to minimal leakage of the circuit separation valve 40 (and the outlet valves 7c, 7d with the front axle circuit I intact). This limits the duration of the dual-circuit operation.

FIG. 2 schematically illustrates a second exemplary embodiment of a brake system for a motor vehicle. The second exemplary embodiment largely corresponds to the first exemplary embodiment. Therefore, the differences between the exemplary embodiments will be discussed below.

Pressure medium reservoir 4 is divided into three reservoir chambers 401, 402, 403 by two partition walls, for example. For example, the pressure medium reservoir 4 comprises a first partition wall 421 and a second partition wall 422, wherein the first reservoir chamber 401 is separated from the third reservoir chamber 403 by the first partition wall 421, and the first reservoir chamber 401 is separated from the second reservoir chamber 402 by the second partition wall 422. With respect to its volume, the third reservoir chamber 403 is smaller than the first reservoir chamber 401 and smaller than the second reservoir chamber 402.

According to the example, the first pressure source 5 includes only one hydraulic port, which is connected to the system pressure line section 38. The system pressure line section 38 (and thus the pressure chamber 37) is connected, on the one hand, via the separation valve 23 and the line section 43 to the third reservoir port 413 of the pressure medium reservoir 4, and thus to the third reservoir chamber 403, and, on the other hand, is connected via the non-return valve 53 and the (replenishment) line section 42 to the first reservoir port 411 of the pressure medium reservoir 4, and thus to the first reservoir chamber 401. According to the example, no non-return valve is connected in parallel with the separation valve 23.

The three reservoir chambers 401, 402, 403 and at least one overflow are arranged and designed such that a (direct) overflow of pressure medium from the third reservoir chamber 403 is only possible into the first reservoir chamber 401 (and not into the second reservoir chamber 402).

By means of line section 38, pressure source 5 or pressure chamber 37 is furthermore connected to the hydraulic port 60 of the first structural unit 100, which is connected via the pressure-resistant hydraulic connecting element 80 to the hydraulic port 61 of the second structural unit 200. Connection 80 is also the only hydraulic pressure connection, in particular the only hydraulic connection, between the first and the second structural unit, according to this exemplary embodiment.

In the second structural unit 200, the pressure sensor 19 is arranged, according to the example, in the brake circuit I.

Advantageously, an internal pressure medium reservoir 75 is provided in the second structural unit, with which the second pressure source 2 is hydraulically connected on the suction side and which in turn is hydraulically connected to the second reservoir chamber 402 for the replenishment of pressure medium. By means of the internal pressure medium reservoir 75, pressure medium for suction for the second pressure source 2 can be kept ready, and therefore suction with lower resistance, in particular at low temperatures, is possible.

1-18. (canceled)

19. A brake system for a motor vehicle having at least four hydraulically actuable wheel brakes, said brake system comprising:
one electrically actuable inlet valve per wheel brake;
a first electrically actuable pressure source and a second electrically actuable pressure source, wherein the first pressure source and the second pressure source are connected to a brake supply line to which the inlet valves are connected;
a pressure medium reservoir having a first reservoir chamber and a second reservoir chamber, wherein the first pressure source is hydraulically connected to the first reservoir chamber, and wherein the second pressure source is hydraulically connected to the second reservoir chamber;
wherein the pressure medium reservoir includes a third reservoir chamber and the first pressure source is connected via an electrically actuable first separation valve to the third reservoir chamber.

20. The brake system as claimed in claim 19, wherein the reservoir chambers are separated from each other by partition walls.

21. The brake system as claimed in claim 19, wherein the third reservoir chamber is smaller than the first reservoir chamber and smaller than the second reservoir chamber.

22. The brake system as claimed in claim 19, further comprising one electrically actuable outlet valve per wheel brake, wherein the outlet valves are normally closed and are connected to the second reservoir chamber.

23. The brake system as claimed in claim 19, further comprising an electrically actuable, normally open, circuit separation valve arranged in the brake supply line such that, when the circuit separation valve is closed, the brake supply line is hydraulically separated into a first line section and a second line section, wherein the first line section is hydraulically connected to the second pressure source and to at least two of the inlet valves, and the second line section is hydraulically connected to the first pressure source and to the other inlet valves, in particular to at least the other two of the inlet valves.

24. The brake system as claimed in claim 19, wherein the first pressure source is connected to the brake supply line via an electrically actuable, normally open, second separation valve.

25. The brake system as claimed in claim 19, further comprising a first structural unit, in which the first electrically actuable pressure source is arranged, and a second structural unit, in which the second electrically actuable pressure source and the electrically actuable inlet valves are arranged, wherein the pressure medium reservoir is arranged on the first structural unit.

26. The brake system as claimed in claim 25, wherein the first structural unit and the second structural unit are connected to one another by at most one pressure-resistant hydraulic connecting element.

27. The brake system as claimed in claim 26, wherein the first structural unit includes a first hydraulic port for connection to the first reservoir chamber, a third hydraulic port for connection to the third reservoir chamber, and a second hydraulic port for connection to the second structural unit, the second hydraulic port being connected to the hydraulic connecting element.

28. The brake system as claimed in claim 27, wherein the first structural unit does not include a further hydraulic port.

29. The brake system as claimed in claim 27, wherein the first pressure source is connected to the second hydraulic port.

30. The brake system as claimed in claim 25, wherein the first separation valve is arranged in the first structural unit.

31. The brake system as claimed in claim 25, wherein the second structural unit comprises at least four hydraulic wheel ports for connection to the wheel brakes, a first hydraulic port for connection to the second reservoir chamber, and a second hydraulic port for connection to the first structural unit, the second hydraulic port being connected to the hydraulic connecting element.

32. The brake system as claimed in claim 25, further comprising an electrically actuable, normally open, circuit separation valve arranged in the brake supply line such that, when the circuit separation valve is closed, the brake supply line is hydraulically separated into a first line section and a second line section, wherein the first line section is hydraulically connected to the second pressure source and to at least two of the inlet valves, and the second line section is hydraulically connected to the first pressure source and to the other inlet valves, in particular to at least the other two of the inlet valves, wherein the circuit separation valve is arranged in the second structural unit.

33. The brake system as claimed in claim 25, wherein the first pressure source is connected to the brake supply line via an electrically actuable, normally open, second separation valve arranged in the second structural unit.

34. The brake system as claimed in claim 19, further comprising at least four wheel ports for the at least four wheel brakes, wherein in a de-energized state of the brake system, both the first reservoir chamber is hydraulically separated from the wheel ports and the second reservoir chamber is hydraulically separated from the wheel ports.

35. The brake system as claimed in claim 19, wherein the first pressure source is connected to the first reservoir chamber via a non-return valve opening in the direction of the first pressure source.

36. The brake system as claimed in claim 19, wherein the reservoir chambers and at least one overflow are arranged and designed in such a way that an overflow of pressure medium from the third reservoir chamber is possible only into the first reservoir chamber.
